(19) United States
(12) Patent Application Publication
(10) Pub. No.: US 2026/0012124 A1
(43) Pub. Date: Jan. 8, 2026

(54) MOUNTING BRACKET FOR SOLAR PANEL FOUNDATION SYSTEM

(71) Applicant: APA SOLAR, LLC, Ridgeville Corners, OH (US)

(72) Inventors: Joseph Von Deylen, Whitehouse, OH (US); Josh Von Deylen, Bryan, OH (US); Shawn Jeremy Ramey, Ney, OH (US); Richard Alan Roth, Archbold, OH (US); Erik Steven Shinabery, Bryan, OH (US)

(21) Appl. No.: 19/262,643

(22) Filed: Jul. 8, 2025

Related U.S. Application Data
(60) Provisional application No. 63/668,490, filed on Jul. 8, 2024.

(51) Int. Cl. H02S 20/30; H02S 30/10

(52) U.S. Cl. CPC H02S 20/30; H02S 30/10

(57) ABSTRACT

A mounting bracket for a solar panel foundation system is disclosed. The mounting bracket can include a top panel having a first side panel and a second side panel extending therefrom. A bearing tube can extend between the side panels to form a through hole. Each side panel can include a cutout. The top panel, first side panel, and second side panel can form a substantially U-shaped configuration. The cutout can be designed to accommodate a torque tube, facilitating rotational movement of solar modules. The bearing tube can be configured to receive a pivot member, enabling selective rotation within the bearing tube. The mounting bracket can decrease the number of brackets and fasteners, thereby militating against potential failure points, cutting assembly time, and minimizing environmental impact.

### CROSS-REFERENCE TO RELATED APPLICATIONS

This application claims the benefit of U.S. Provisional Application No. 63/668,490, filed on Jul. 8, 2024. The entire disclosure of the above application is incorporated herein by reference.

### FIELD

The present technology relates to structural components for solar panel assemblies, and, more particularly, to a mounting bracket for a solar panel foundation system.

### INTRODUCTION

This section provides background information related to the present disclosure which is not necessarily prior art.

In solar energy applications, the effectiveness and durability of a mounting system can be important for the performance and longevity of a solar panel. The mounting system can employ an I-beam structure as a foundational support, to which additional components, such as brackets and fasteners, can be attached. The additional components can secure a bearing housing assembly (BHA), which can support a torque tube that can adjust an orientation of the solar panel throughout the day in response to a changing angle of incidence of sunlight, thereby maximizing solar energy capture and improving overall system efficiency.

Although the I-beam configuration can offer a robust structural foundation, it can also introduce several challenges. For example, the use of numerous separate coupling components can increase system complexity and elevate the risk of mechanical failure. Multipiece brackets and fasteners can act as potential failure points and can necessitate regular inspection and maintenance to preserve the integrity of the mounting system. Additionally, the assembly process of the I-beam structure and additional coupling components can be labor-intensive, requiring careful alignment and secure fastening of each component.

Adoption of a universal design to accommodate different types of solar trackers can add complexity. Although a universal design can offer versatility, it can require additional brackets and fasteners to adapt the system to various tracker specifications, potentially compromising structural integrity and operational efficiency. The environmental impact associated with the production and disposal of these additional components can also be significant, where the manufacture of extra brackets and fasteners consumes more resources and results in increased emissions and waste. As the solar industry expands, the environmental implications of its support infrastructure become more pressing.

Accordingly, there is a need for a mounting system for solar panels that can address the inefficiencies and complexities of existing designs. Desirably, a mounting system that reduces the number of brackets and fasteners would decrease potential failure points, reduce assembly time, and minimize environmental impact. Such improvements would enhance the durability and reliability of solar panel installations and support the sustainability of the solar energy sector.

### SUMMARY

In concordance with the instant disclosure, a mounting system for solar panels that addresses the inefficiencies and complexities of existing designs by reducing the number of brackets and fasteners, decreasing potential failure points, reducing assembly time, and minimizing environmental impact, has been surprisingly discovered. The present technology includes articles of manufacture, systems, and processes that relate to the mounting of one or more solar panels using an A-frame structure configured to directly integrate a tracker bearing housing assembly (BHA) with the foundation, thereby eliminating the need for additional brackets and fasteners.

In certain embodiments, a mounting bracket for a solar panel foundation system is provided. The mounting bracket can include a top panel having a first side panel and a second side panel, with the first side panel and the second side panel extending away from the top panel. A bearing tube can extend between the first side panel and the second side panel to form a through hole therewith. The first side panel and the second side panel can each include a cutout.

In certain embodiments, a solar panel foundation system is provided. The solar panel foundation system can include a solar panel foundation and a mounting bracket secured to the solar panel foundation. The solar panel foundation system can further include a torque tube and a pivot member, where the pivot member can be selectively rotatable within the bearing tube. As the pivot member rotates, the torque tube can move between adjacent circular portions of cutouts of the first side panel and the second side panel to enable rotational movement of a solar module.

In certain embodiments, a method of installing a mounting bracket on a solar panel foundation system is provided. The method can include providing the mounting bracket. The method can further include securing the mounting bracket to the solar panel foundation system, which can involve aligning apertures of the side panels with corresponding apertures in a member of the solar panel foundation system and disposing a fastener through the aligned apertures.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a mounting bracket for a solar panel foundation system, according to an embodiment of the present disclosure;

FIG. 2 is a bottom perspective view of the mounting bracket for a solar panel foundation system, according to the embodiment shown in FIG. 1;

FIG. 3 is a front elevational view of the mounting bracket for a solar panel foundation system, according to the embodiment shown in FIG. 1;

FIG. 4 is a right-side elevational view of the mounting bracket for a solar panel foundation system, according to the embodiment shown in FIG. 1;

FIG. 5 is a top plan view of the mounting bracket for a solar panel foundation system, according to the embodiment shown in FIG. 1;

FIG. 6 is a bottom plan view of the mounting bracket for a solar panel foundation system, according to the embodiment shown in FIG. 1;

FIG. 7 is a top perspective view of a mounting bracket coupled to a portion of a solar panel foundation system, according to another embodiment of the present disclosure;

FIG. 8 is a front elevational view of the mounting bracket depicted coupled to a solar panel foundation system, according to an embodiment of the present disclosure; and

FIG. 9 is a front elevational view of the mounting bracket depicted coupled to a portion of a solar panel foundation system in a first configuration, according to an embodiment of the present disclosure;

FIG. 10 is a front elevational view of the mounting bracket depicted coupled to a portion of a solar panel foundation system in a second configuration, according to an embodiment of the present disclosure;

FIG. 11 is a front elevational view of the mounting bracket depicted coupled to a portion of a solar panel foundation system in a third configuration, according to an embodiment of the present disclosure; and

FIG. 12 is a flow chart illustrating a method of installing a mounting bracket on a solar panel foundation system.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology can improve the installation and operational efficiency of a solar panel foundation system by providing a mounting bracket that can integrate a tracker bearing housing assembly directly with the solar panel foundation. This integration can militate against the need for additional brackets and fasteners, thereby simplifying the assembly process. The U-shaped configuration of the mounting bracket, including a top panel and a pair of side panels, can facilitate the coupling of a torque tube 204, which can serve as a central axis for a rotational movement of a solar module. The inclusion of a cutout in each of the side panels, the cutouts designed to receive a torque tube 204, and a bearing tube disposed between the side panels, can allow for the rotational movement of a solar module. This design can enable angular adjustment of the orientation of the solar module, enhancing adaptability of the system to varying installation sites. Additionally, the design of the mounting bracket can reduce the number of components and potential wear points, thereby enhancing the overall reliability and durability of the solar panel foundation system.

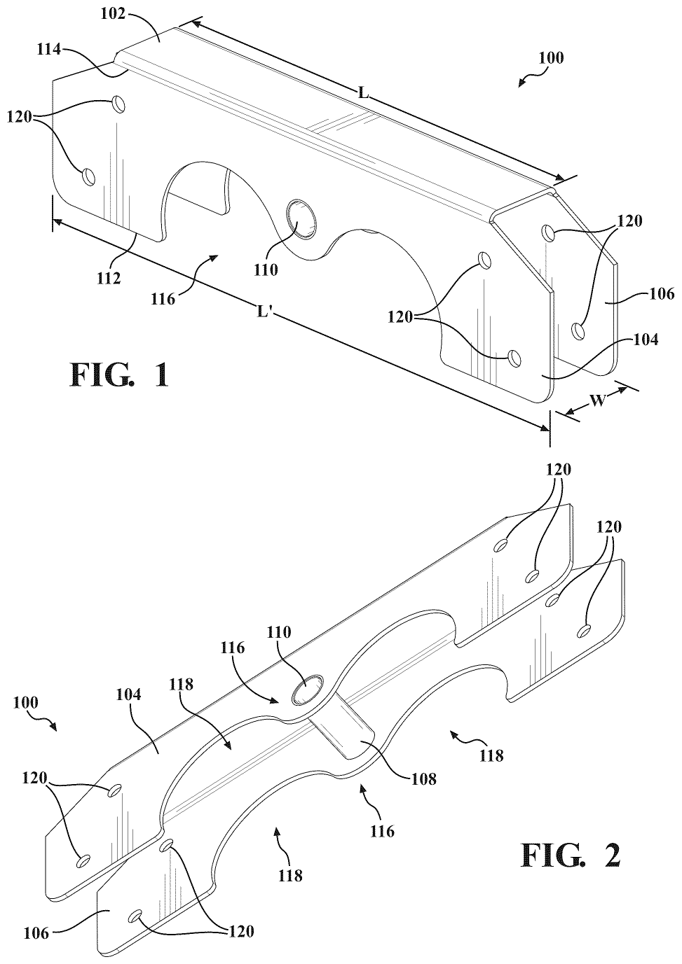

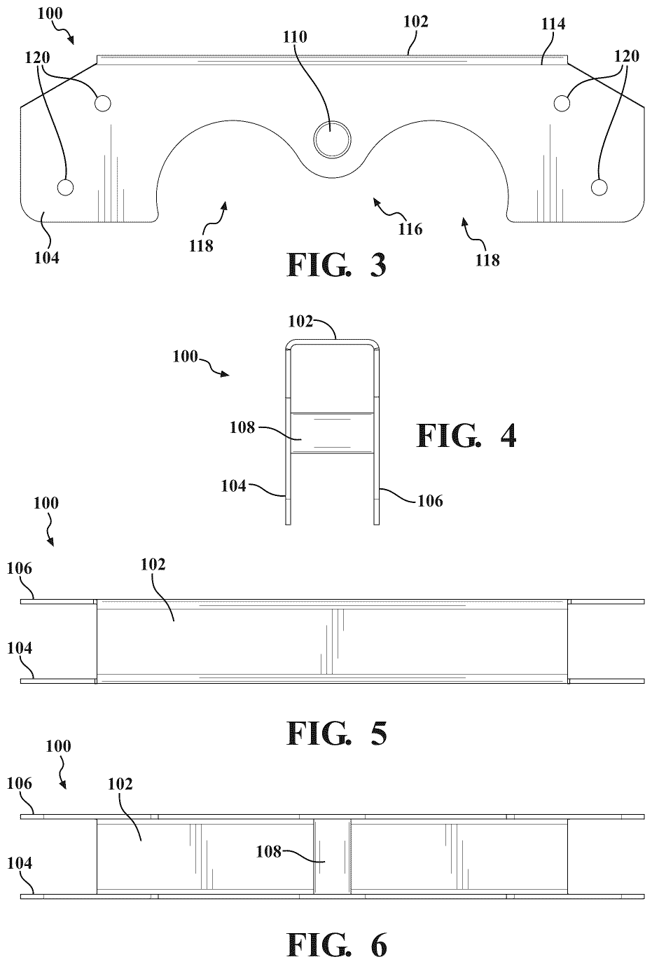

In certain embodiments, and with reference to FIGS. 1-7, a mounting bracket 100 for a solar panel foundation system 200 is shown. The mounting bracket 100 can be utilized with certain solar panel foundation systems 200. For example, reference is made to U.S. Patent Application Publication No. US 2023/0332368, published on Oct. 19, 2023, the entire disclosure of which is incorporated herein by reference. The referenced patent application describes a solar panel foundation system 200 that includes a bracket, braces, and members 203, which can serve as a basis for the enhancements detailed in this document. It should be appreciated that the mounting bracket 100 of the present disclosure can be utilized within other solar panel foundation systems 200 within the scope of the present disclosure.

The mounting bracket 100 can include a top panel 102, which can serve as the primary structural component from which other elements extend. The top panel 102 can include a material suitable for prolonged exposure to environmental conditions, such as galvanized steel or aluminum, to enhance durability and resistance to corrosion.

A first side panel 104 and a second side panel 106 can extend from the top panel 102. The first side panel 104 and the second side panel 106 can be oriented substantially perpendicular to the top panel 102, forming a generally U-shaped configuration along a longitudinal axis of the mounting bracket 100. The U-shaped design can also facilitate the efficient distribution of loads across the mounting bracket 100, militating against the likelihood of deformation or failure under load. The first side panel 104 and the second side panel 106 can provide lateral support and stability to the mounting bracket 100, ensuring that the structure can maintain integrity under various load conditions. The first side panel 104 and the second side panel 106 can include the same corrosion-resistant material as the top panel 102 to ensure uniformity in performance and longevity.

In certain embodiments, and with reference to FIGS. 1-3, a length L of the top panel 102 can be less than a length L′ of each of the first side panel 104 and the second side panel 106. The extended length of the first side panel 104 and the second side panel 106 relative to the top panel 102 can distribute loads, thereby militating against stress concentrations and potential deformation under operational conditions. Additionally, the longer side panels 104, 106 can facilitate integration with the solar panel foundation system, allowing for secure coupling and improved alignment with the solar panel foundation system.

In certain embodiments, the mounting bracket 100 can have a length L′ that is greater than a width W, resulting in a mounting bracket 100 that can be longer than it is wide. This design can contribute to the structural stability and load distribution capabilities of the mounting bracket 100. By having a greater length relative to its width, the mounting bracket 100 can provide an extended surface area for attachment to the solar panel foundation and militate against the likelihood of displacement under operational loads. The longer length can provide more flexibility in aligning the mounting bracket 100 with the foundation, accommodating various installation site requirements.

A bearing tube 108 can be disposed between the first side panel 104 and the second side panel 106. The bearing tube 108 can be centrally located to facilitate the rotational movement of a pivot member 208, which can be part of a torque tube assembly (not shown). The bearing tube 108 can extend between the first side panel 104 and the second side panel 106 to form a through hole 110. The through hole 110 can provide a passage for the pivot member 208, enabling its selective rotation within the bearing tube 108. The through hole 110 can be dimensioned to ensure a snug fit with the pivot member 208, minimizing play and ensuring precise control over the rotational movement of the solar panels.

In certain embodiments, the bearing tube 108 can be centrally disposed along the length L′ of the first side panel 104 and the length L′ of the second side panel 106. The central positioning can ensure that a load borne by the bearing tube is distributed across the first side panel 104, the second side panel 106, and onto the top panel 102 of the mounting bracket 100, militating against the likelihood of deformation or imperfect performance under load.

In certain embodiments, the bearing tube 108 can be disposed such that its central axis is equidistant from a lower horizontal edge 112 and an upper horizontal edge 114 of the first side panel 104 and the second side panel 106. This positioning can ensure that the loads are distributed across the mounting bracket 100 in a relatively even fashion. In certain embodiments, the bearing tube 108 can include a lubrication port (not shown). The lubrication port can facilitate the application of a lubricant to the bearing tube 108, militating against friction and wear during operation.

In certain embodiments, the bearing tube 108 can include a low-friction material, in the form of an insert or coating, for example, in order to militate against mechanical wear during rotation of the pivot member 208. The low-friction material can include polytetrafluoroethylene (PTFE), ultra-high-molecular-weight polyethylene (UHMW-PE), nylon, or a polymer-based composite. The use of a low-friction material can enhance the performance and longevity of the mounting bracket 100, thereby reducing maintenance requirements and costs. One having ordinary skill in the art can select a suitable material for the bearing tube 108 and the low-friction material within the scope of the present disclosure.

In certain embodiments, and with reference to FIGS. 1-3, the first side panel 104 and the second side panel 106 can each include a cutout 116. The cutout 116 can be designed to receive the torque tube 204, which can serve as the central axis for the rotational movement of the solar module (not shown). The cutout 116 can be designed with adjacent circular portions 118 to facilitate the positioning of the torque tube 204. The cutout 116 can be designed to allow for the accommodation of torque tubes 204 with varying diameters, enhancing the adaptability of the mounting bracket 100 to different solar panel systems. The cutout 116 can allow the torque tube 204 to be directly received and supported within the mounting bracket 100, thereby eliminating the need for a separate bearing housing assembly to connect the torque tube 204, which can reduce the number of components and potential failure points in the solar panel foundation system.

In certain embodiments, and with reference to FIGS. 1-3 and 7, the cutout 116 can include two adjacent circular portions 118. The adjacent circular portions 118 can be designed to accommodate the torque tube 204, allowing it to move freely between the adjacent circular portions 118 of the first side panel 104 and the second side panel 106. The adjacent circular portions 118 can be dimensioned to ensure a close fit with the torque tube 204. For example, each circular portion 118 of the cutout 116 can be complementary to an outer surface of the torque tube 204, where a diameter of each circular portion 118 can be substantially the same as a diameter of the torque tube 204 when the torque tube 204 has a circular cross-section. In operation, the torque tube 204 can move along an arc between the adjacent circular portions 118 of the cutouts 116 in the first side panel 104 and the second side panel 106. The movement of the torque tube 204 is facilitated by a pivot point, which is established at the bearing tube 108. The bearing tube 108 can serve as the central axis around which the torque tube 204 rotates.

In certain embodiments, the cutout 116 can define a non-linear profile with alternating radiused valleys and peaks. This profile can enhance the engagement between the cutout 116 and the torque tube 204, providing additional stability and support. The alternating valleys and peaks can be designed to accommodate variations in the torque tube 204 shape and/or diameter, allowing for flexibility in the design and installation of the solar panel system.

In certain embodiments, and with reference to FIGS. 1-3, the first side panel 104 and the second side panel 106 can each include one or more apertures 120. The apertures 120 can receive and secure a member 203 of the solar panel foundation system, facilitating the alignment and attachment of the mounting bracket 100 to the solar panel foundation system. The apertures 120 can be arranged in a linear pattern, extending at an angle relative to a horizontal edge of the first side panel 104 and the second side panel 106, to allow for angular adjustment of the mounting bracket 100.

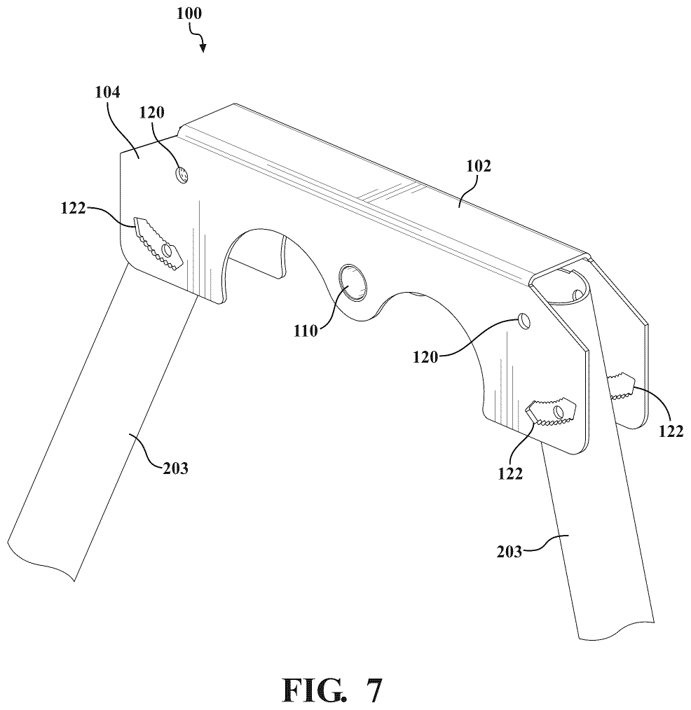

In certain embodiments, and with reference to FIG. 7, the apertures 120 can include a slot 122 to allow positional adjustment of the mounting bracket 100 relative to the solar panel foundation system. The slot 122 can be designed to accommodate various fasteners, enabling the coupling of the mounting bracket 100 to the foundation. The inclusion of the slot 122 can provide flexibility in the positioning of the mounting bracket 100, allowing for adjustments to be made to accommodate site-specific requirements. In certain embodiments, the slot 122 can include teeth 124 to allow multiple set positions. The teeth 124 can engage with corresponding features on the member of the solar panel foundation system. The use of teeth 124 can enhance the stability of the mounting bracket 100, militating against unwanted movement or slippage during operation. The members 203 can be pivotable in the mounting bracket 100 in operation, allowing for angular adjustment and alignment flexibility during installation and throughout the operational life of the solar panel foundation system 200. The pivotable nature of the members 203 within the mounting bracket 100 can allow the solar panel foundation system 200 to accommodate site-specific elevation requirements and ensure optimal alignment of the mounting bracket 100 according to the specific installation conditions. The pivotable nature of the mounting bracket 100 can enable the mounting bracket 100 to adapt to varying terrain conditions and foundation orientations while maintaining structural integrity.

In certain embodiments, the bearing tube 108 can be disposed above the cutout 116 in a portion of the side panels 104, 106 that depends between the circular portions 118 of the cutout 116 in each side panel 104, 106. This positioning can facilitate the efficient transfer of loads from the torque tube 204 to the mounting bracket 100, enhancing the overall stability and support of the system. The placement of the bearing tube 108 above the cutout 116 can also provide additional clearance for the torque tube 204, militating against the likelihood of interference or obstruction during operation.

In certain embodiments, the top panel 102, the first side panel 104, and the second side panel 106 can include a corrosion-resistant material. This material can be suitable for prolonged exposure to harsh environmental conditions, including salt spray, high humidity, and ultraviolet (UV) radiation. The corrosion-resistant material can include galvanized steel, stainless steel, aluminum, marine-grade aluminum alloy, anodized aluminum, glass fiber-reinforced polymer (GFRP), or corrosion-resistant polymer composite. The selection of the corrosion-resistant material can be based on the specific requirements of the installation site, including environmental conditions and load requirements. The use of a corrosion-resistant material can enhance the durability and longevity of the mounting bracket 100, reducing the likelihood of degradation over time. One having ordinary skill in the art can select a suitable corrosion-resistant material within the scope of the present disclosure.

In certain embodiments, the top panel 102, the first side panel 104, and the second side panel 106 can include a corrosion-resistant coating. This corrosion-resistant coating can provide an additional layer of protection against environmental factors, enhancing the durability and longevity of the mounting bracket 100. The corrosion-resistant coating can hot-dip galvanization, zinc-aluminum-magnesium (Zn—Al—Mg) alloy coating, zinc-nickel plating, anodization, epoxy powder coating, and ceramic-based protective coating. The selection of the corrosion-resistant coating can be based on the specific requirements of the installation site, including environmental conditions and load requirements. The use of a corrosion-resistant coating can militate against the likelihood of degradation or failure over time, minimizing maintenance requirements and costs. One having ordinary skill in the art can select a suitable corrosion-resistant coating within the scope of the present disclosure.

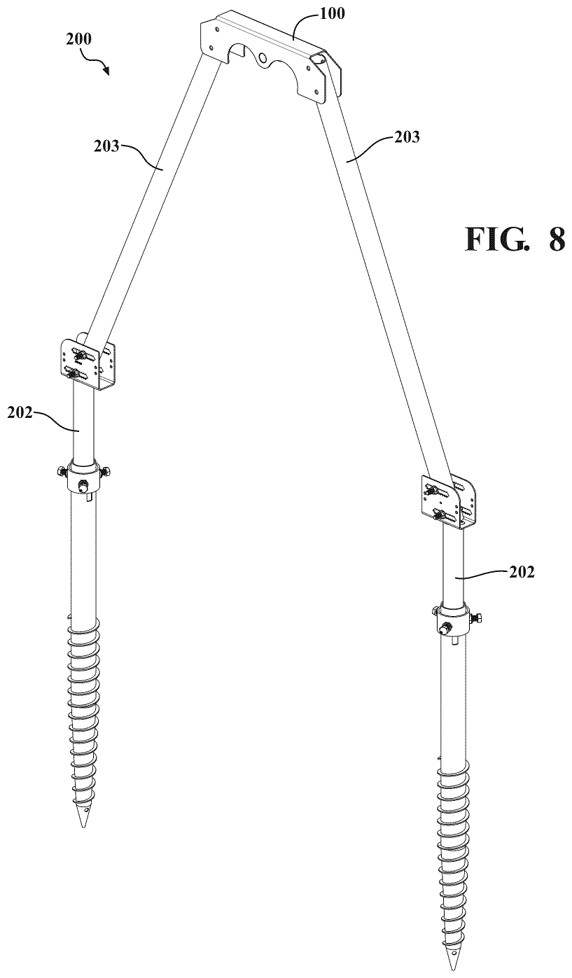

In certain embodiments, and with reference to FIG. 8, a solar panel foundation system 200 is provided. The solar panel foundation system 200 can include a solar panel foundation 202, which can provide a stable base for the installation of solar modules. The solar panel foundation system 200 can include a mounting bracket 100 as described herein. The mounting bracket 100 can facilitate the secure attachment of solar modules to the solar panel foundation 202. The mounting bracket 100 can include a top panel 102, a first side panel 104, and a second side panel 106, with the first side panel 104 and the second side panel 106 extending away from the top panel 102 to form a generally U-shaped configuration.

The solar panel foundation system 200 can include a torque tube 204 to support and rotate a solar module 206. The torque tube 204 can extend longitudinally along the solar module 206 and can serve as a structural element designed to resist bending and torsional forces. The torque tube 204 can include steel, aluminum, or other suitable materials to provide strength and corrosion resistance. The torque tube 204 can be coupled to a pivot member 208 that can facilitate rotational movement of the torque tube 204 relative to the solar panel foundation system 200. The pivot member 208 can include bearings, bushings, or other rotational interfaces. The connection between the torque tube 204 and the pivot member 208 can be achieved through welding, bolting, or other mechanical fastening methods, ensuring a secure and stable assembly while allowing the necessary rotational freedom for solar tracking operations. The solar panel foundation system 200 can be designed to support the installation and alignment of the solar module 206, thereby reducing the complexity and time required for assembly. The integration of the mounting bracket 100 with the solar panel foundation 202 can militate against the need for additional components and potential failure points, thereby enhancing the overall reliability and durability of the solar panel foundation system 200.

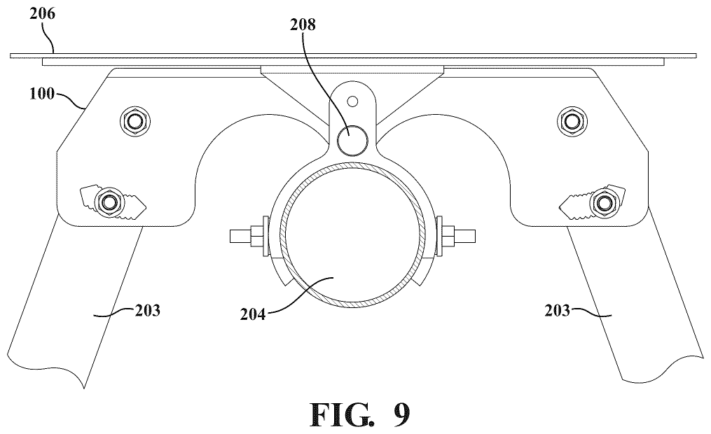

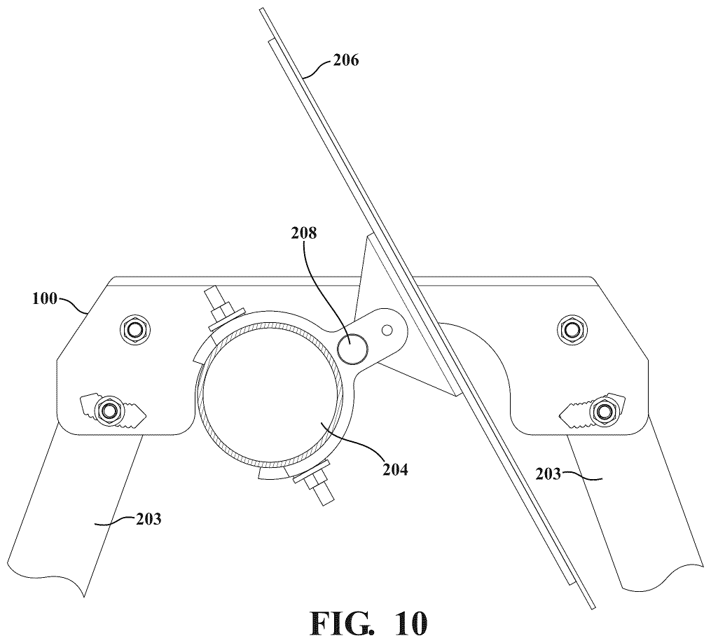

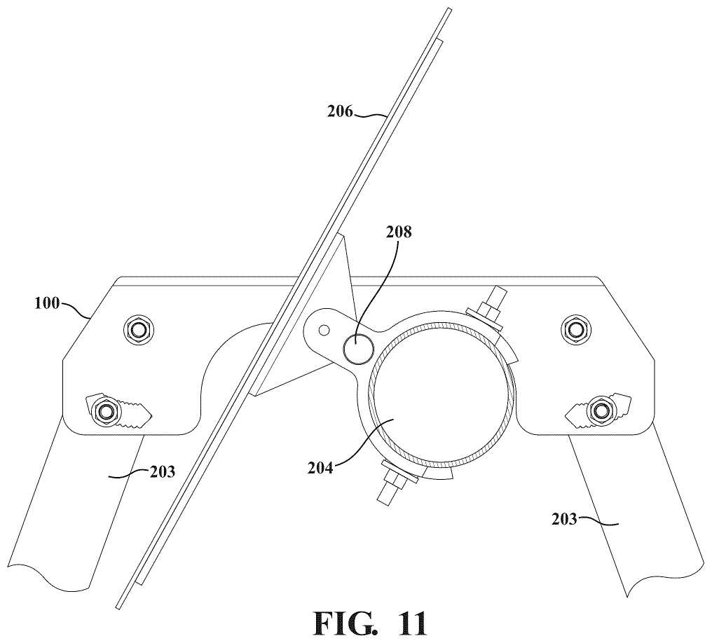

FIGS. 9-11 illustrate a front elevational view of the mounting bracket 100 depicted coupled to a portion of a solar panel foundation system 200. In FIGS. 9-11, the mounting bracket 100 is shown in various configurations, demonstrating the rotation ability of a solar module 206 relative to the mounting bracket 100. In FIG. 9, the mounting bracket 100 is depicted in a first position or neutral position, with the solar module 206 aligned horizontally. In this neutral position, the torque tube 204 can be positioned centrally within the cutout 116 of the mounting bracket 100 and located beneath the bearing tube 108. FIG. 10 illustrates the mounting bracket 100 with the torque tube 204 rotated to a second position or an inclined position. In this second position, the torque tube 204 can be positioned within one of the adjacent circular portions of the cutout 116. FIG. 11 shows the mounting bracket 100 with the torque tube 204 rotated to a third position or a declined position. In this third position, the torque tube 204 can be positioned within the other of the adjacent circular portions of the cutout 116.

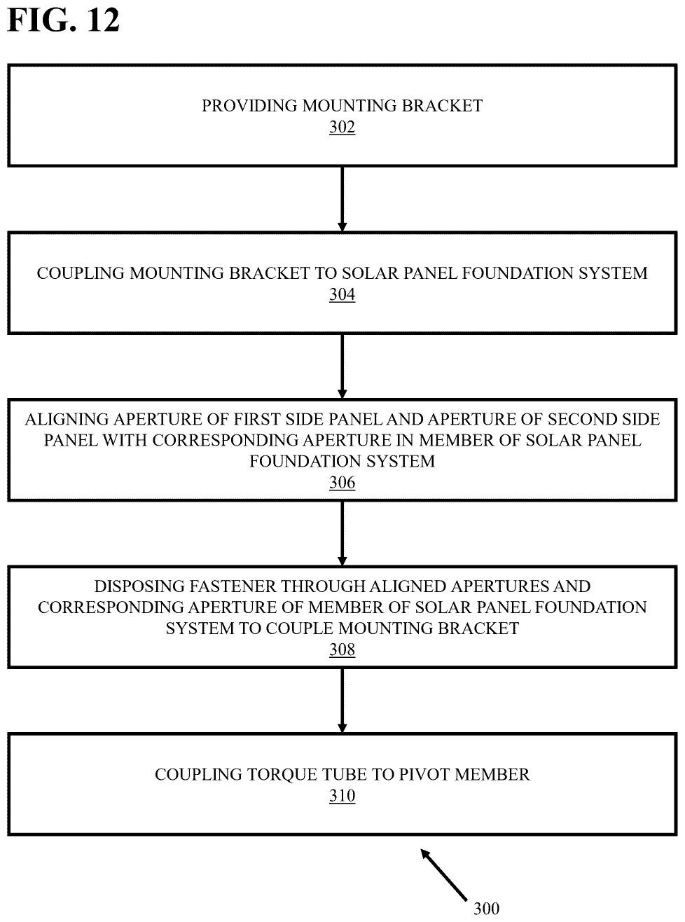

In certain embodiments, and with reference to FIG. 12, a method 300 of installing a mounting bracket 100 on a solar panel foundation system 200 is provided. The method 300 can include a step 302 of providing a mounting bracket 100 as described herein. The method 300 can include a step 304 of securing the mounting bracket 100 to the solar panel foundation system. Step 304 can include aligning an aperture 120 of the first side panel 104 and an aperture 120 of the second side panel 106 with a corresponding aperture in a member of the solar panel foundation system. The method 300 can further include a step 306 of disposing a fastener through the aligned apertures 120 and the corresponding aperture of the member of the solar panel foundation system to secure the mounting bracket 100. The method 300 can further include a step 308 of inserting a pivot member 208 into the bearing tube 108. This step 308 can facilitate the rotational movement of the solar modules by allowing the pivot member 208 to rotate within the bearing tube 108. The method 300 can include a step 310 of coupling a torque tube 204 to the pivot member 208. This coupling can enable the torque tube 204 to serve as the central axis for the rotational movement of the solar modules, allowing for adjustments to be made to the orientation based on the position of the sun.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A mounting bracket for a solar panel foundation system, comprising:
a top panel having a first side panel and a second side panel, the first side panel and the second side panel extending away from the top panel; and
a bearing tube disposed between the first side panel and the second side panel;
wherein
the first side panel and the second side panel each include a cutout, and
the bearing tube extends between the first side panel and the second side panel to form a through hole therewith.

2. The mounting bracket of claim 1, wherein the top panel, the first side panel, and the second side panel form a substantially U-shape.

3. The mounting bracket of claim 1, wherein a length of the top panel is less than a length of each of the first side panel and the second side panel.

4. The mounting bracket of claim 1, wherein the mounting bracket has a length and a width, the length greater than the width.

5. The mounting bracket of claim 1, wherein the first side panel and the second side panel each include a plurality of apertures.

6. The mounting bracket of claim 5, wherein the plurality of apertures is arranged in a linear pattern extending at an angle relative to a horizontal edge of one of the first side panel and the second side panel.

7. The mounting bracket of claim 5, wherein each aperture of the plurality of apertures of the first side panel is axially aligned with a corresponding aperture of the plurality of apertures of the second side panel.

8. The mounting bracket of claim 5, wherein the plurality of apertures includes a slot configured to allow positional adjustment of the mounting bracket relative to the solar panel foundation system.

9. The mounting bracket of claim 8, wherein the slot includes teeth configured to allow multiple set positions.

10. The mounting bracket of claim 1, wherein the cutout forms a continuous edge.

11. The mounting bracket of claim 1, wherein the cutout includes two circular portions.

12. The mounting bracket of claim 11, wherein the two circular portions are spaced apart along a longitudinal axis of the mounting bracket.

13. The mounting bracket of claim 11, wherein the bearing tube is disposed above the cutout in a portion of the side panel that depends between the two circular portions of the cutout in each side panel.

14. The mounting bracket of claim 1, wherein the bearing tube is centrally disposed along a length of the first side panel and a length of the second side panel.

15. The mounting bracket of claim 1, wherein the bearing tube is disposed such that its central axis is equidistant from a lower horizontal edge and an upper horizontal edge of the first side panel and the second side panel.

16. A solar panel foundation system, comprising:
a solar panel foundation;
a mounting bracket secured to the solar panel foundation, the mounting bracket including:
a top panel having a first side panel and a second side panel, the first side panel and the second side panel extending away from the top panel; and
a bearing tube disposed between the first side panel and the second side panel;
wherein
the first side panel and the second side panel each include a cutout having adjacent circular portions, and
the bearing tube extends between the first side panel and the second side panel to form a through hole therewith;
a torque tube; and
a pivot member;
wherein the pivot member is selectively rotatable within the bearing tube, and as the pivot member rotates, the torque tube moves between the adjacent circular portions of the cutout of the first side panel and the second side panel to enable rotational movement of a solar module.

17. A method of installing a mounting bracket on a solar panel foundation system, comprising:
providing the mounting bracket, the mounting bracket including:
a top panel having a first side panel and a second side panel, the first side panel and the second side panel extending away from the top panel; and
a bearing tube disposed between the first side panel and the second side panel;
wherein
the first side panel and the second side panel each include a cutout, and
the bearing tube extends between the first side panel and the second side panel to form a through hole therewith, and
the first side panel and the second side panel each include a plurality of apertures; and
coupling the mounting bracket to the solar panel foundation system.

18. The method of claim 17, wherein coupling the mounting bracket to the solar panel foundation system includes aligning one aperture of the plurality of apertures of the first side panel and one aperture of the plurality of apertures of the second side panel with a corresponding aperture in a member of the solar panel foundation system, and disposing a fastener through the one aperture of the plurality of apertures of the first side panel, the corresponding aperture of the member of the solar panel foundation system, and the one aperture of the plurality of apertures of the second side panel.

19. The method of claim 17, further comprising inserting a pivot member into the bearing tube.

20. The method of claim 19, further comprising coupling a torque tube to the pivot member.
